(19) United States
(12) Patent Application Publication
(10) Pub. No.: US 2013/0199860 A1
(43) Pub. Date: Aug. 8, 2013

(54) ARMOUR PROTECTION ASSEMBLY FOR A VEHICLE

(71) Applicant: Rainer Paulsen, Berlin (DE)

(72) Inventor: Rainer Paulsen, Berlin (DE)

(73) Assignee: FEV GmbH, Aachen (DE)

(21) Appl. No.: 13/366,564

(22) Filed: Feb. 6, 2012

(51) Int. Cl. B60K 1/00; F41H 5/04

(52) U.S. Cl. 180/65.1; 89/36.02; 89/912; 89/929

(57) ABSTRACT

An armour protection assembly for a vehicle comprising an armour plate and a layer of a fibre composite material which is arranged on the armour plate, wherein between the armour plate and the layer of fibre composite material there is received at least one battery cell being part of a battery comprising a plurality of battery cells connected in series.

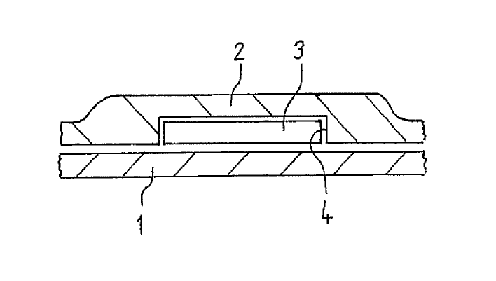

### FIELD OF THE INVENTION

The invention relates to an armour protection assembly for a vehicle comprising an armour plate and a layer of a fibre composite material being arranged on the armour plate.

### BACKGROUND OF THE INVENTION

Armour protection assemblies using a fibre composite material are widely known. Such composite plates serve to armour motor vehicle interiors in order to protect people sitting inside the motor vehicle being shot at. Primarily the armour plate which represents a layer of the composite plate of the amour protection assembly serves to provide protection from projectiles. In case a projectile penetrates the armour plate, the layer of fibre composite material has the purpose at least of reducing the scatter angle of the projectile emerging inside the motor vehicle or even stopping said projectile.

Furthermore, to an increasing extent, hybrid vehicles and electric vehicles for which electric energy is provided in batteries are being used. In addition, hybrid vehicles and purely electrically driven vehicles are increasingly used in off-highway vehicles. A central problem consists in accommodating the relatively large battery modules which are required for feeding the electrical machines. In the case of hybrid vehicles or purely electrically driven machines, the vehicle interior is greatly reduced in size as a result of the installation of the battery modules. Therefore, a solution wherein the batteries of hybrid vehicles or of purely electrically driven motor vehicles can be accommodated in the motor vehicle in a space saving way would be desirable.

### SUMMARY OF THE INVENTION

In armoured vehicles, it is possible to accommodate the batteries in a space saving way by providing an armour protection assembly as disclosed herein. A further solution consists in proposing a vehicle body in which an armour protection assembly includes a fibre composite material having aramid fibres or glass fibres.

The special advantage of the inventive armour protection assembly and of the inventive vehicle body is that the individual battery cells, which are electrically connected together in a battery, are not, as usual, received in a common housing, but are arranged de-centrally inside the armour protection assembly or at the vehicle body. The individual battery cells are clearly smaller and, as a rule, have a planar shape, so that they can be arranged in a space-saving way inside the armour protection assembly or at different vehicle body parts.

The batteries are preferably lithium polymer cells. They do not include liquid electrolytes, but an electrolyte based on a polymer which can have gel-like properties. The battery cells are advantageous in that, if damaged, they cannot leak. Furthermore, they are normally molded or shaped into a flexible plastic coating and comprise a planar shape, so that they can be accommodated in a space-saving way.

In a preferred embodiment, the layer of fibre composite material, per battery cell has a recess which faces the armour plate and in which there is received at least one battery cell.

Furthermore, between the armour plate and the layer of fibre composite material or inside the layer of fibre composite material there are arranged cables and/or at least one control device of the battery, which means that, in principle, the entire battery including the battery cells and the necessary electronics as well as the cables are arranged inside the armour plating assembly.

The layer of fibre composite material preferably consists of a plurality of fibre mattings which are glued to one another and which, together, can have a thickness of several centimetres. For this purpose, and for accommodating the battery cell, there can be produced a recess in the layer of fibre composite material. This is preferably achieved in such a way that some of the fibre mattings are partially cut out, with the cut-outs being positioned one above the other, so that there occurs a through-hole through the super-imposed fibre mattings. Finally, on one side, a plurality of fibre mattings is placed over the recess in order to close the through-hole. The individual fibre mattings are glued to one another and then glued on to the armour plate or mechanically connected in any other way. In the same way it is possible for recesses for control devices and channels for cables to be produced in the layer of fibre composite material. However, the cables can also be arranged in channels between two fibre mailings not provided with recesses, so the cables do not have to be in contact with the armour plate. In this way, the cables can be fully integrated into the layer of fibre composite material. In principle, this is also conceivable for the control devices or the battery cell.

The armour plate is preferably a steel plate. The fibre composite material can be aramid fibres and/or glass fibres.

When arranging the battery cells at or onto different vehicle body parts, the battery cells can be arranged between a vehicle body plate and an inner lining of the motor vehicle.

### BRIEF DESCRIPTION OF THE DRAWING

A preferred embodiment of the armour plating assembly will be explained in greater detail with reference to the Figure which is a diagrammatic illustration of armour protection assembly in a longitudinal section.

### DETAILED DESCRIPTION OF THE INVENTION

The armour protection assembly comprises an armour plate 1 which is preferably provided in the form of a steel plate. On one side of the armour plate 1 facing the motor vehicle interior, there is applied a layer of a fibre composite material 2, for example a glass fibre composite material or an aramid fibre composite material. Between the armour plate 1 and the layer of fibre composite material 2, there is arranged a battery cell 3, preferably a lithium polymer cell. In the present case, the layer of fibre composite material 2 is provided with a recess 4 which faces the armour plate 1 and in which the battery cell 3 is received.

The battery cell 3 is thus integrated into the layer of the fibre composite material 2 and forms part of the armour plating. The battery cell 3 takes over the task of providing a passive protection against projectiles. In addition, the battery cell 3 provides active protection while projectiles are penetrating, in that, with a penetrating material, there occurs a high short circuit current which is capable of melting projectile parts.

In addition, the battery cell 3 also has a sound proofing effect and can be designed in such a way that resonance frequencies are displaced positively. Furthermore, the battery cell has a certain internal stiffness and internal strength and is therefore able to contribute to the stability of the entire armour protection assemblies and thus to the stability of the vehicle body.

The foregoing description is illustrative of one or more embodiments of the invention, but is not meant to be a limitation upon the practice thereof. The following claims, including all equivalents thereof, are intended to define the scope of the invention.

I claim:

1. An armour protection assembly for a vehicle comprising: an armour plate and a layer of a fibre composite material arranged on the armour plate, wherein between the armour plate and the layer of fibre composite material there is received at least one battery cell being part of a battery comprising a plurality of battery cells electrically connected to each other.

2. An armour protection assembly according to claim 1, wherein the battery cells are lithium polymer cells.

3. An armour protection assembly according to claim 1, wherein in the layer of fibre composite material, per battery cell, there is provided a recess which faces the armour plate and in which there is received the at least one battery cell.

4. An armour protection assembly according to claim 1, wherein cables and/or at least one control device of the battery are arranged between the armour plate and the layer of fibre composite material or inside the layer of fibre composite material.

5. An armour protection assembly according to claim 1, wherein the armour plate is a steel plate.

6. An armour protection assembly according to claim 1, wherein the fibre composite material comprises aramid fibres or glass fibres.

7. A vehicle body with a plurality of battery cells which are electrically connected to each other and form a battery, wherein the battery cells are fixed to different body parts.

8. A vehicle body according to claim 7, wherein at least one of the body parts constitutes an armour protection assembly having: an armour plate and a layer of a fibre composite material arranged on the armour plate, wherein between the armour plate and the layer of fibre composite material there is received at least one battery cell being part of a battery comprising a plurality of battery cells electrically connected to each other.

9. A vehicle body according to claim 7, wherein at least one of the battery cells is arranged between a vehicle body plate and an inner lining.
